(19) United States
(12) Patent Application Publication
(10) Pub. No.: US 2006/0160975 A1
(43) Pub. Date: Jul. 20, 2006

(54) Polymer compound, polymer-containing composition containing the same

(75) Inventors: Sakae Suda, Tokyo (JP); Koichi Sato, Tokyo (JP); Ikuo Nakazawa, Tokyo (JP); Masayuki Ikegami, Tokyo (JP); Keiichiro Tsubaki, Tokyo (JP); Ryuji Higashi, Tokyo (JP); Keiko Yamagishi, Tokyo (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/546,546

(22) PCT Filed: May 19, 2004
(86) PCT No.: PCT/JP04/07146

§ 371 Date: Aug. 22, 2005

(30) Foreign Application Priority Data
May 19, 2003 (JP) 2003-140257
May 19, 2003 (JP) 2003-140256
May 12, 2004 (JP) 2004-142834

(51) Int. Cl. C08F 218/02

(52) U.S. Cl. 526/330

(57) ABSTRACT

Disclosed herein are a polymer compound having at least two block segments, wherein at least one segment of the block segments contains a repeating unit structure exhibiting anionicity and a repeating unit structure exhibiting hydrophilicity, and an ink composition containing the polymer, a solvent or dispersing medium, and a coloring material.

### TECHNICAL FIELD

The present invention relates to a novel block polymer useful as various functional materials, a polymer-containing composition containing the same, an ink composition, and a method and an apparatus for applying an ink using the ink composition, and particularly to a block polymer useful as a dispersing agent, an aqueous dispersion material as a functional-material-dispersed composition, which is preferably useful as an ink composition for image-forming materials used in printers, displays, etc., and a method and an apparatus for applying an ink using the ink composition.

### BACKGROUND ART

As aqueous dispersion materials containing particulate solids, have heretofore been well known agricultural chemicals such as herbicides and insecticides, medicaments such as anti-cancer drugs, anti-allergic drugs and antiphlogistics, coloring materials containing a colorant as particulate solids, such as inks and toners. In recent years, digital printing technology has been vigorously developed. Typical examples of this digital printing technology include those called electrophotographic technology and ink-jet technology, and importance of its existence as image-forming technology in homes and offices has more and more increased in recent years.

Among these, the ink-jet technology has a great feature as a direct recording method that it is compact and low in consumed power. The formation of high-quality images is also quickly advanced by formation of micro-nozzles or the like. An example of the ink-jet technology includes a method that an ink fed from an ink tank is evaporated and bubbled by heating it by a heater in a nozzle, thereby ejecting the ink to form an image on a recording medium. Another example includes a method that an ink is ejected from a nozzle by vibrating a piezoelectric element.

Since aqueous dye solutions are generally used as inks used in these ink-jet methods, bleeding may occur in some cases when inks of different colors overlap with each other, or a phenomenon called feathering may appear in a direction of fibers in paper at a recorded portion on a recording medium. In order to improve these problems, it is investigated to use pigment-dispersed inks. For example, a method that a pigment is dispersed with a nonionic polymer to stereoscopically inhibit aggregation of the pigment, and a method that a pigment is dispersed by an ionic block polymer having at least one hydrophilic component and at least one hydrophobic component have been proposed. However, a further improvement is desired in point of inhibiting aggregation by interaction between particles to stably disperse the pigment in a solvent over a long period of time and from the viewpoints of tint and coloring ability (U.S. Pat. No. 5,085,698). In addition, in some cases, the color may adhere when an image is rubbed after printing, a smeared image trailing edge may appear when a marker follows the image, or the ink may adhere to another paper when prints are stacked on each other after printing. Therefore, a further improvement is desired in point of fixing ability to a recording medium.

### DISCLOSURE OF THE INVENTION

It is an object of the present invention to provide an ink composition, in which a functional material is a pigment or dye, a solvent is water, the dispersibility of the pigment or dye is good, and fixing ability to a recording medium is excellent.

Another object of the present invention is to provide an ink composition, by which the dispersion stability of a functional material such as a pigment or dye in a solvent is high, and the tint and coloring of the resulting printed image are good.

The above objects can be achieved by the present invention described below.

According to the present invention, there is thus provided a polymer compound having at least two block segments, wherein at least one segment of the block segments contains a repeating unit structure exhibiting anionicity and a repeating unit structure exhibiting hydrophilicity.

According to the present invention, there is also provided a polymer compound comprising a first repeating unit structure exhibiting anionicity and a second repeating unit structure different from the first repeating unit structure, wherein the compositional ratio of the first repeating unit structure to the second repeating unit structure gradually changes along a monomer chain.

According to the present invention, there is further provided a polymer-containing composition comprising the polymer compound according to the present invention, a solvent or dispersing medium and a functional material.

According to the present invention, there is still further provided an ink composition comprising the polymer compound according to the present invention, a solvent or dispersing medium and a coloring material.

According to the present invention, there is still further provided a method for applying an ink, which comprises the steps of preparing the ink composition according to the present invention and applying the ink composition to a medium.

According to the present invention, there is yet still further provided an apparatus for applying an ink, which comprises an ink-applying means for applying the ink composition to a medium by causing energy to act on the ink composition according to the present invention and a driving means for driving the ink-applying means.

According to the present invention, there can be provided a block polymer compound, by which a functional material can well be dispersed.

According to the present invention, there can also be provided an ink composition using the block polymer, in which a functional material is a pigment or dye, a solvent is water, and the dispersibility of the pigment or dye is good, and an ink composition having excellent fixing ability to a recording medium.

According to the present invention, there can further be provided an ink composition for ink-jet, by which the dispersion stability of a functional material such as a pigment or dye in a solvent is high, and the tint and coloring of the resulting printed image are good.

According to the present invention, there can still further be provided a method for applying a liquid using such an ink composition as described above, and an apparatus for applying a liquid, which is used in the method.

### BRIEF DESCRIPTION OF THE DRAWINGS

FIG. 1 schematically illustrates a mechanism of an image-recording apparatus according to the present invention.

### BEST MODE FOR CARRYING OUT THE INVENTION

The present invention will hereinafter be described in detail.

A block polymer according to the present invention has at least two block segments, wherein at least one segment of the block segments contains a repeating unit structure exhibiting anionicity and a repeating unit structure exhibiting hydrophilicity.

A polymer compound according to the present invention comprises a first repeating unit structure exhibiting anionicity and a second repeating unit structure different from the first repeating unit structure, wherein the compositional ratio of the first repeating unit structure to the second repeating unit structure gradually changes along a polymer chain. In the polymer compound, the different repeating unit structure may preferably exhibit hydrophilicity, and the polymer compound may be composed of a block polymer having at least two block segments, in which in at least one block segment of the block polymer, at least one repeating unit structure exhibiting anionicity and at least one repeating unit structure exhibiting hydrophilicity gradually change along a polymer chain.

In the block polymer compound, a principal component may preferably be amphipathic. The amphipathic property is developed by the condition that at least one block segment in the block polymer is solvophobic, and at least one block segment is solvophilic. A hydrophilic solvent is preferred as an object of the solvophobicity and solvophilicity. In other words, the block polymer according to the present invention preferably has at least one hydrophobic segment and at least one hydrophilic segment. The block polymer is more preferably of a block form of AB, ABA, ABC or the like.

Specific examples of the block polymer usable in the present invention include acrylic or methacrylic block polymers, block polymers composed of polystyrene and any other addition polymerization system or condensation polymerization system, and block polymers having polyoxyethylene and polyoxyalkylene blocks.

In the present invention, a block polymer containing a polyalkenyl ether structure is preferably used, and a block polymer containing a polyvinyl ether structure is more preferably used. In the present invention, the block polymer may be a graft polymer containing the polyvinyl ether structure. A certain segment of the block polymer may be either a copolymer segment or a gradient segment.

The block polymer preferably used in the present invention and containing the polyvinyl ether structure will hereinafter be described. A synthetic process of a polymer containing a polyvinyl ether structure has been reported (Japanese Patent Application Laid-Open No. H11-080221). A process by cationic living polymerization (Japanese Patent Application Laid-Open Nos. H11-322942 and H11-322866) is representative thereof. By conducting polymer synthesis by the cationic living polymerization, various polymers such as homopolymers, copolymers composed of two or more monomers, block polymers and graft polymers can be synthesized with their chain lengths (molecular weights) exactly made uniform. For example, another vinyl ether monomer is gradually added in the process of polymerizing one vinyl ether monomer, thereby synthesizing a polymer (gradient copolymer), in which a monomer composition is gradually changed along its polymer chain. In comparison with a block polymer, an influence on thermal stimuli responsiveness due to difference in monomer sequence distribution has been reported (Polymer Preprints, Japan, Vol. 51, No. 7 (2002)). In addition, various functional groups can be introduced into side chains of polyvinyl ether. Besides, the cationic polymerization may be conducted in a HI/12 system, HCl/SnCl₄ system or the like.

The structure of the block polymer containing a polyvinyl ether structure may be a copolymer composed of vinyl ether and another polymer.

No particular limitation is imposed on the repeating unit structure exhibiting anionicity used in the present invention. For example, it is a repeating unit structure having a carboxylic acid in its side chain, like a polymer obtained by polymerizing acrylic acid, methacrylic acid or the like. According to a first embodiment of the present invention, it forms a block segment with a repeating unit structure exhibiting hydrophilicity. According to a second embodiment of the present invention, at least one repeating unit structure forms a block segment, in which a composition gradually changes along a polymer chain, with at least one repeating unit structure different from the first-mentioned repeating unit structure and preferably exhibiting hydrophilicity.

In the repeating unit structure exhibiting anionicity, for example, the repeating unit structure having a carboxylic acid in its side chain, the side chain means that a carboxylic acid is not directly bonded to a high-molecular main chain, but is present through some linking group. For example, it means that a carboxylic acid is not present in the form directly bonded to a polymer of acrylic acid or methacrylic acid, but is present in the form bonded through a linking group such as an alkylene group or alkyleneoxy group.

The linking group is preferably composed of at least three atoms, more preferably at least five atoms away from the main chain. The carboxylic acid is preferably present sufficiently away from the main chain because a structure that the carboxylic acid is present in the form directly bonded to the main chain may not fully exhibit an interaction to be operated between molecules or within a molecule due to limitation of mobility of the carboxylic acid. Accordingly, a structure that the carboxylic acid is present in a free form is mentioned as a preferred form.

In the amphipathic block polymer used in the present invention, the repeating unit structure exhibiting the anionicity is preferably a repeating unit structure represented by the following general formula (1), and the repeating unit structure exhibiting the hydrophilicity is preferably a repeating unit structure represented by the following general formula (2).

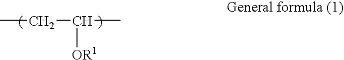

In the general formula (1), R¹ is —X—(COO—)ₛ, and X is a linear, branched or cyclic alkylene group having 1 to 20 carbon atoms, or —(CH(R²)—CH(R³)—O)ₚ(CH₂)ₘ—, (CH₂)ₘ—(O)ₙ—(CH₂)_{q}— or a structure that at least one of these methylene groups is substituted by a carbonyl group or an aromatic structure, in which p is an integer of from 1 to 18, s is an integer of from 1 to 3, m is an integer of from 1 to 36, n is 1 or 0, q is an integer of from 1 to 18, and R² and R³ are alkyl groups and may be the same or different from each other.

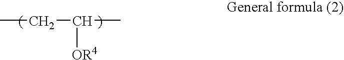

In the general formula (2), R⁴ is hydrogen or selected from —(CH(R⁵)—CH(R⁶)—O)ₚ—R⁷ and —(CH₂)ₘ—(O)ₙ—R⁷, in which p is an integer of from 1 to 18, m is an integer of from 1 to 36, n is 1 or 0, R⁵ and R⁶ are, independently of each other, hydrogen or —CH₃, and R⁷ is hydrogen or a linear, branched or cyclic alkyl group having 1 to 5 carbon atoms.

Specific examples of the repeating unit structure exhibiting the anionicity and represented by the general formula (1) are mentioned below. However, the present invention is not limited thereto.

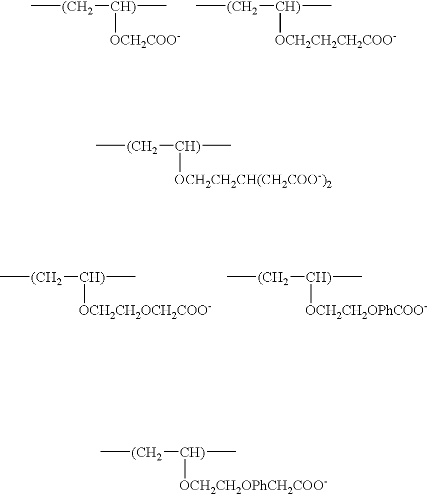

In the above-mentioned formulae, Ph denotes a phenylene group.

Specific examples of the repeating unit structure exhibiting the hydrophilicity and represented by the general formula (2) are mentioned below. However, the present invention is not limited thereto.

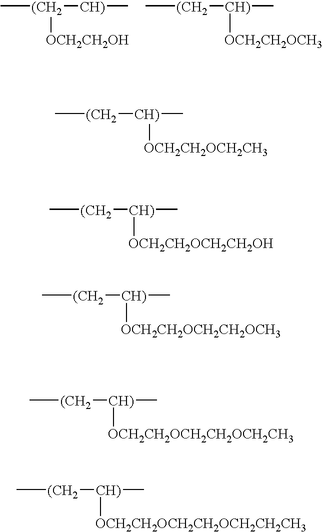

In the present invention, it is desired that the content of the anionic repeating unit structure in the segment containing at least one anionic repeating unit structure represented by the general formula (1) and at least one hydrophilic repeating unit structure represented by the general formula (2) is within a range of from 0.5 to 99 mol %, preferably from 1 to 90 mol %. If the content is lower than 0.5 mol %, the interaction of the resulting polymer to be operated by the carboxylic acid may become insufficient in some cases. If the content exceeds 99 mol %, the interaction may overact on the contrary, and the function may become insufficient in some cases. It is hence not preferable to contain the anionic repeating unit structure in such a too low or high content.

In the present invention, the content of at least one repeating unit structure exhibiting the hydrophilicity in the block segment containing at least one repeating unit structure exhibiting the anionicity and at least one repeating unit structure exhibiting the hydrophilicity is preferably not lower than 50 mol %, more preferably not lower than 80 mol %. If the content is lower than 50 mol %, the interaction may overact, and the function may become insufficient in some cases.

In the present invention, the condition that the compositional ratio between the repeating unit structures represented by the general formulae (1) and (2) is gradually changed along the polymer chain means, for example, a case where a proportion of the repeating unit structure represented by the general formula (1) to the repeating unit structure represented by the general formula (2) in the block segment is gradually reduced along the polymer chain.

The hydrophobic block segment of the amphipathic block polymer used in the present invention preferably contains a repeating unit structure represented by the following general formula (3).

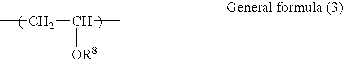

In the formula (3), R⁸ is selected from a linear, branched or cyclic alkyl group having 1 to 18 carbon atoms, Ph, Pyr, Ph-Ph, Ph-Pyr, —(CH(R⁹)—CH(R¹⁰)—O)ₚ—R¹¹ and —(CH₂)ₘ (O)ₙ—R¹¹, in which hydrogen and carbon in the aromatic ring may be substituted by a linear or branched alkyl group having 1 to 4 carbon atoms and nitrogen, respectively, p is an integer of from 1 to 18, m is an integer of from 1 to 36, n is 1 or 0, R⁹ and R¹⁰ are, independently of each other, hydrogen or —CH₃, and R¹¹ is a linear, branched or cyclic alkyl group having 1 to 18 carbon atoms, Ph, Pyr, Ph-Ph, Ph-Pyr, —CHO, —CO—CH═CH₂, —CO—C(CH₃)═CH₂ or —CH₂COOR¹², with the proviso that hydrogen bonded to carbon may be substituted by a linear or branched alkyl group having 1 to 4 carbon atoms, F, Cl or Br, and carbon in the aromatic ring may be substituted by nitrogen, and R¹² is an alkyl group having 1 to 4 carbon atoms.

In the present invention, -Ph, -Pyr, -Ph-Ph and -Ph-Pyr denote phenyl, pyridyl, biphenyl and pyridylphenyl groups, respectively. With respect to the pyridyl, biphenyl and pyridylphenyl groups, they may be any positional isomers.

Specific examples of the repeating unit structure represented by the general formula (3) are mentioned below. However, the present invention is not limited thereto. 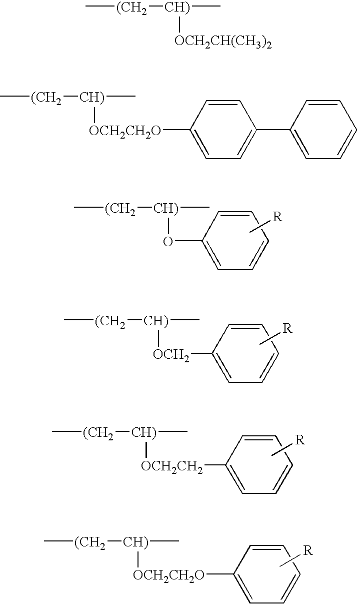
wherein R is hydrogen or a linear or branched alkyl group having 1 to 4 carbon atoms.

In the present invention, the amphipathic block polymer preferably used in the present invention can be obtained by, for example, conducting synthesis by selecting a hydrophilic block segment from the repeating unit structures of the general formulae (1) and (2) and a hydrophobic block segment from the repeating unit structures of the general formula (3). In the present invention, the block polymer can be obtained by, for example, conducting synthesis by selecting a hydrophilic block segments, in which a monomer composition of the repeating unit structures of the general formulae (1) and (2) gradually changes along the polymer chain, and a hydrophobic block segment from the repeating unit structures of the general formula (3).

The number average molecular weight (Mn) of the block polymer compound according to the present invention is within a range of from 200 to 10,000,000, preferably from 1,000 to 1,000,000. If the molecular weight exceeds 10,000,000, entanglement within a polymer chain and between polymer chains becomes too much, and so such a polymer may be hard to be dispersed in a solvent. If the molecular weight is lower than 200, the molecular weight may be too low to exhibit a three-dimensional effect as a polymer. A preferable polymerization degree of each block segment is from 3 to 10,000, preferably from 5 to 5,000, more preferably from 10 to 4,000.

The molecular weight distribution Mw (weight average molecular weight)/Mn (number average molecular weight) of the block polymer used in the present invention is preferably at most 2.0, more preferably at most 1.6.

In order to improve dispersion stability and inclusion property, the molecular motion of the block polymer is preferably more flexible because such a polymer becomes easy to physically entangle with a surface of a functional substance and have affinity for it. Therefore, the glass transition temperature Tg of the main chain of the block polymer is preferably at most 20° C., more preferably at most 0° C., still more preferably at most −20° C. In this regard, the polymer having the polyvinyl ether structure is preferably used because it generally has such properties that it has a low glass transition temperature and is flexible or soft.

According to the present invention, there is provided a polymer-containing composition comprising a solvent or dispersing medium, a functional material and the block polymer according to the first embodiment of the present invention or the polymer compound according to the second embodiment of the present invention. The composition contains the block polymer or polymer compound described above and a functional material exhibiting a useful prescribed function, such as a coloring material. The block polymer or polymer compound can be suitably used for well dispersing the functional material.

The functional material is a material having a prescribed function, and examples thereof include compounds, mixtures, solids, liquids and materials of other forms. As specific examples thereof, may be mentioned materials usable in agricultural chemicals such as herbicides and insecticides, materials usable in medicaments such as anti-cancer drugs, anti-allergic drugs and antiphlogistics, materials usable in cosmetics such as lipsticks, foundations, rouges and moisturizing creams, coloring materials such as dyes, pigments and color pigments, and compositions thereof. In the present invention, the coloring materials such as dyes, pigments and color pigments are preferably used.

In the present invention, the functional material and block polymer are dispersed in the form of particles in a solvent. As examples of the particles dispersed in the solvent, may be mentioned particles with a functional material having a prescribed function dispersed singly, particles with the functional material dispersed in the form adsorbed on the hydrophilic segment of the block polymer, particles with the functional material included in the block polymer and particles formed by the block polymer alone. All the functional material having a prescribed function is preferably in a state included in the block polymer. As a preferable example of the state that the functional material is included in the block polymer, is mentioned a state that the functional material is included in a polymer micelle formed by the block polymer.

The content of the functional material having a prescribed function contained in the polymer-containing composition is from 0.1% by weight to 70% by weight, preferably from 0.5% by weight to 50% by weight, more preferably from 1% by weight to 30% by weight. If the content is lower than 0.1% by weight, the prescribed function may not be exhibited in some cases. If the content exceeds 70% by weight, the resulting composition may have a too high viscosity in some cases.

When the polymer-containing composition according to the present invention is applied to an ink composition, interaction between particles, the dispersion stability and tinting strength of a coloring-material-dispersed ink, and brightness of its color are greatly affected by a particle diameter of dispersed particles and evenness of the particle diameter. In other words, if aggregation occurs between particles dispersed in a solvent, the particles greatly grow. As a result, they precipitate, and so a stable dispersed ink composition cannot be obtained. Since the particle diameter and tinting strength reside in an inversely proportional relation (Annalen der Physik, Vol. 25, p. 377, 1908), the tinting strength and brightness of the color are lowered if the particle diameter is great, or a particle diameter distribution is broad even when the particle diameter is small.

The composition according to the present invention is a composition which achieves as its objects the stabilization of particle dispersion and the improvements of tinting strength and brightness of the color and contains dispersed particles prevented from aggregating between particles and having a small particle diameter and a narrow particle diameter distribution.

The amphipathic block polymer used in the present invention has a block segment containing at least one hydrophilic repeating unit structure and at least one anionic repeating unit structure. Therefore, a coloring material can be included in micelles formed by the block polymer. Since a shell part has the hydrophilic repeating unit structure, the coloring material can be dispersed in a hydrophilic solvent. In other words, a coloring-material-included type ink composition can be formed. Since the shell part of the micelle has the anionic repeating unit structure at the same time, the polymer micelle particles, in which the coloring material is included, also exhibit anionicity. Accordingly, aggregation between polymer micelle particles is prevented by electrical repulsion, and the particles can be stably dispersed in a solvent. In addition, the particle diameter of the particles in the dispersed composition can be made very even and uniform. The inclusion of the coloring material in the polymer is preferred from the viewpoint of permitting improving its environmental stability. The condition that the coloring material is included in the polymer micelle can be confirmed by, for example, the fact that the functional material is not dispersed in the solvent when no polymer micelle is present, and the functional material is separated in the solvent when the polymer micelle is collapsed by some method. The inclusion can also be observed through an electron microscope or the like.

In order to anionize a functional group exhibiting anionicity, such as a carboxyl group, a basic additive such as calcium hydroxide or sodium hydroxide is added. When repeating unit structures exhibiting anionicity are distributed at random in a block segment, the functional group can be fully anionized because the carboxyl group is not closely present. As a result, the polymer micelle particles are also fully anionized and prevented from aggregating by electrical repulsion, and so they can be stably dispersed in the solvent. Even when recording on a recording medium is conducted with the ink composition according to the present invention by a thermal ink-jet system that thermal energy is applied to an ink to bubble the ink, thereby conducting recording, stable ejection becomes feasible without precipitation or aggregation and clogging at an orifice. In addition, stable formation of an image can be conducted without ejection failure of an ink even when ejection of the ink is suspended for a while.

The average particle diameter of the micelle particles of the block polymer can be measured by a photon correlation method or the like. In the present invention, measurement by a dynamic light-scattering method that is the photon correlation method is mainly used. As an index to the evenness of the particle diameter, is used an index of degree of dispersion μ/G² (μ: a secondary coefficient of cumulant development, G: attenuation constant) indicated by Gulari et al. (The Journal of Chemical Physics, Vol. 70, p. 3965, 1979). This value is also determined by the dynamic light-scattering method. Particle diameter measuring apparatus by the dynamic light-scattering method include apparatus such as DLS7000 manufactured by Otsuka Electronics Co., Ltd.

The average particle diameter of the micelle particles of the block polymer used in the present invention is preferably smaller than 200 nm. at most 2.0, more preferably at most 1.6. Index of degree of dispersion μ/G² is preferably lower than 0.2.

When the polymer according to the present invention is applied to the ink composition, the composition exhibits excellent fixing ability to a recording medium by addition of stimuli by application of a cation upon formation of an image or without the addition.

The polymer in the present invention forms micelles of the block polymer, in which the hydrophilic block segment exhibiting anionicity in a hydrophilic solvent becomes a shell part, and the hydrophobic block segment becomes a core part. When external stimuli, for example, a cation are applied to this polymer-micelle-dispersed composition, the polymer micelle particles are gathered through electrical attractive force operated between the anion and cation. As a result, phase transition and viscosity increase occur. Since the proportion of one hydrophilic repeating unit structure to one anionic repeating unit structure in the hydrophilic polymer segment of the block polymer according to the present invention gradually changes along its polymer chain, the anionicity is more exhibited as it is more away from the core part, namely closer to the side of the shell part, and electrical attractive force effectively acts between the micelle particles. On the other hand, the hydrophilic polymer segment present near to the core part contains a greater amount of the hydrophilic repeating unit structure, and so the hydrophilicity is retained even when aggregation occurs between micelle particles, whereby the micelle aggregated does not precipitate, but gels and thickens, thereby achieving good fixing ability. In the case of an ink composition with a water-soluble dye dissolved in a hydrophilic solvent on the other hand, aggregation occurs when the composition comes into contact with a cation upon formation of an ink because the dye is anionic. However, the coloring material itself aggregates and precipitates in a state exposed, and so the fixing ability may be lowered in some cases.

The block polymer having the polyvinyl ether structure in the present invention has a glass transition temperature of at most 20° C. for its main chain and is flexible in molecular motion. Therefore, when the ink composition according to the present invention well entangles with the coloring material and a recording medium when it is ejected on the recording medium to form an image, the image is formed in such a state that the coloring material has been fully included in the polymer micelle, and high fixing ability to the recording medium is exhibited.

A composition, in which a coloring material such as a dye, pigment or color pigment is used as the functional material contained in the composition, is preferably used as an ink composition.

The ink composition according to the present invention will be described.

Specific examples of dyes, organic pigments and inorganic pigments used in ink compositions are mentioned.

The dyes used in the present invention may be those publicly known, and such water-soluble dyes such as direct dyes, acid ayes, basic dyes, reactive dyes and food dyes, and insoluble colorants as described below may be used.

Examples of water-soluble dyes include

direct dyes such as C.I. Direct Black 17, 62 and 154; C.I. Direct Yellow 12, 87 and 142; C.I. Direct Red 1, 62 and 243; C.I. Direct Blue 6, 78 and 199; C.I. Direct Orange 34 and 60; C.I. Direct Violet 47 and 48; C.I. Direct Brown 109; and C.I. Direct Green 59,

acid dyes such as C.I. Acid Black 2, 52 and 208; C.I. Acid Yellow 11, 29 and 71; C.I. Acid Red 1, 52 and 317; C.I. Acid Blue 9, 93 and 254; C.I. Acid Orange 7 and 19; and C.I. Acid Violet 49,

reactive dyes such as C.I. Reactive Black 1, 23 and 39; C.I. Reactive Yellow 2, 77 and 163; C.I. Reactive Red 3, 111 and 221; C.I. Reactive Blue 2, 101 and 217; C.I. Reactive Orange 5, 74 and 99; C.I. Reactive Violet 1, 24 and 38; C.I. Reactive Green 5, 15 and 23; and C.I. Reactive Brown 2, 18 and 33, and

C.I. Basic Black 2; C.I. Basic Red 1, 12 and 27; C.I. Basic Blue 1 and 24; C.I. Basic Violet 7, 14 and 27; and C.I. Food Black 1 and 2.

As examples of oil-soluble dyes, commercially available products of various colors are mentioned below.

As examples of oil-soluble dyes of black, may be mentioned C.I. Solvent Black 3, 22:1 and 50. However, the present invention is not limited thereto.

As examples of oil-soluble dyes of yellow, may be mentioned C.I. Solvent Yellow 1, 25:1 and 172. However, the present invention is not limited thereto.

As examples of oil-soluble dyes of orange, may be mentioned C.I. Solvent Orange 1, 40:1 and 99. However, the present invention is not limited thereto.

As examples of oil-soluble dyes of red, may be mentioned C.I. Solvent Red 1, 111 and 229. However, the present invention is not limited thereto.

As examples of oil-soluble dyes of violet, may be mentioned C.I. Solvent Violet 2, 11 and 47. However, the present invention is not limited thereto.

As examples of oil-soluble dyes of blue, may be mentioned C.I. Solvent Blue 2, 43 and 134. However, the present invention is not limited thereto.

As examples of oil-soluble dyes of green, may be mentioned C.I. Solvent Green 1, 20 and 33. However, the present invention is not limited thereto.

As examples of oil-soluble dyes of brown, may be mentioned C.I. Solvent Brown 1, 12 and 58. However, the present invention is not limited thereto.

In the present invention, a pigment and a dye may be used in combination.

The dye used in the ink composition according to the present invention is preferably used in an amount of from 0.1 to 50% by weight based on the weight of the ink composition. If the amount is less than 0.1% by weight, a more sufficient image density may not be achieved in some cases. If the amount exceeds 50% by weight, the viscosity of the resulting ink composition may become too high in some cases. A more preferable range of the amount is from 0.5% by weight to 30% by weight.

The pigment may be either an organic pigment or an inorganic pigment. As pigments used in inks, are used a black pigment and pigments of three primary colors. Incidentally, other color pigments than those described above, colorless or light-colored pigments and metalescent pigments may also be used. In the present invention, commercially available pigments may be used, or newly synthesized pigments may be used.

Examples of commercially available pigments in black, cyan, magenta and yellow are mentioned below.

As examples of black pigments, may be mentioned Raven 1060 (product of Columbian Carbon Co.), MOGUL L (product of Cabot Company), Color Black FW1 (product of Degussa AG) and MA100 (product of Mitsubishi Chemical Corporation). However, the present invention is not limited thereto.

As examples of cyan pigments, may be mentioned C.I. Pigment Blue 15:3, C.I. Pigment Blue 15:4 and C.I. Pigment Blue 16. However, the present invention is not limited thereto.

As examples of magenta pigments, may be mentioned C.I. Pigment Red 122, C.I. Pigment Red 123 and C.I. Pigment Red 146. However, the present invention is not limited thereto.

As examples of magenta pigments, may be mentioned C.I. Pigment Red 122, C.I. Pigment Red 123 and C.I. Pigment Red 146. However, the present invention is not limited thereto.

As examples of yellow pigments, may be mentioned C.I. Pigment Yellow 74, C.I. Pigment Yellow 128 and C.I. Pigment Yellow 129. However, the present invention is not limited thereto.

The pigment used in the ink composition according to the present invention is preferably used in an amount of from 0.1 to 50% by weight based on the weight of the ink composition. If the amount is less than 0.1% by weight, a more sufficient image density may not be achieved in some cases. If the amount exceeds 50% by weight, the viscosity of the resulting ink composition may become too high in some cases. A more preferable range of the amount is from 0.5% by weight to 30% by weight.

No particular limitation is imposed on the solvent contained in the ink composition according to the present invention. The solvent means a medium in which components contained in the ink composition can be dissolved, suspended or dispersed. In the present invention, solvents include organic solvents such as various kinds of linear, branched and cyclic aliphatic hydrocarbons, aromatic hydrocarbons, and heterocyclic aromatic hydrocarbons, hydrophilic solvents, and water.

In the ink composition according to the present invention, water and hydrophilic solvents may be suitably used.

Examples of the hydrophilic solvents include polyhydric alcohols such as ethylene glycol, diethylene glycol, triethylene glycol, polyethylene glycol, propylene glycol, polypropylene glycol and glycerol, polyhydric alcohol ethers such as ethylene glycol monomethyl ether, ethylene glycol monoethyl ether, ethylene glycol monobutyl ether, diethylene glycol monoethyl ether and diethylene glycol monobutyl ether, and nitrogen-containing solvents such as N-methyl-2-pyrrolidone, substituted pyrrolidone and triethanolamine. In order to accelerate drying of the ink composition on paper, a monohydric alcohol such as methanol, ethanol or isopropanol may also be used.

The content of water and the hydrophilic solvent used in the ink composition according to the present invention is preferably within a range of from 20 to 95% by weight based on the total weight of the aqueous dispersion. A range of from 30 to 90% by weight is more preferred. Other components than those described above may be contained in the polymer-containing composition according to the present invention. Additives such as ultraviolet absorbents, antioxidants and stabilizers may also be contained.

The content of the block polymer contained in the ink composition according to the present invention is desirably from 0.1 to 50% by weight, preferably 0.5 to 30% by weight. If the content of the block polymer is lower than 0.1% by weight, the dye or pigment contained in the ink composition according to the present invention may not be fully dispersed in some cases. If the content exceeds 50% by weight, the viscosity of the resulting ink composition may become too high in some cases.

According to a preferred embodiment of the present invention, there is provided a functional-material-dispersed composition having a pH of at least 5, in which a functional material and the block polymer are dispersed in a form of particles in the solvent. The pH value is preferably at least 7.

The ink composition can have responsiveness to stimuli. According to this stimuli responsiveness, good fixing ability can be imparted by viscosity increase of the ink composition by giving stimuli in the process of forming an image. As species of the stimuli given, that suitable for formation of an image is selected from temperature change, exposure to electromagnetic waves, pH change, concentration change, etc. in addition to the above-described application of a cation.

The functional material-dispersed composition according to the present invention can change its state (properties) in response to various stimuli. In the present invention, the application of a cation has been mentioned above as “stimuli”. However, as other examples thereof, may be mentioned temperature change; application of an electric field; exposure to light (electromagnetic waves) such as ultraviolet light, visible light or infrared light; pH change of the composition; addition of a chemical substance; and concentration change of the composition.

In the present invention, preferable stimuli in addition to the application of a cation mentioned above include those described below. A first stimulus is temperature change, and a range of the temperature change is a range of from a temperature lower than the phase transition temperature of the composition to a temperature higher than the phase transition temperature. A second stimulus is exposure to electromagnetic waves, and the wavelength range of the electromagnetic waves is preferably from 100 to 800 nm. A third stimulus is pH change of the composition, and a range of pH change is preferably from pH 3 to pH 12. A fourth stimulus is concentration change of the composition, and examples thereof may include concentration changes of the composition by evaporating or absorbing the solvent in the composition or by changing the concentration of the polymer dissolved in the composition. A range of the concentration change is preferably a range between concentrations before and after the composition causes phase transition. In the present invention, at least two stimuli may be applied in combination.

In the present invention, as changes of a state responded to the stimuli, may be mentioned a phase change from a sol state to a gel state, a phase from a solution state to a solid state, and a change of a chemical structure. The term “stimuli responsiveness” as used in the present invention means that the composition according to the present invention changes its nature in response to such stimuli as described above. In other words, the stimuli responsiveness means that when stimuli such as temperature change, application of an electric field, exposure to electromagnetic waves, pH change, addition of a chemical substance or concentration change of the composition is applied to the composition, the form or physical properties of the composition are markedly changed in response to the stimuli (environmental change).

The nature (state, properties) to change in the composition according to the present invention can be variously selected as necessary for the end application intended of the composition according to the present invention. For example, the composition causes a phase change (for example, a change from sol to gel) by the stimuli to improve its fixing ability to a recording medium.

Various additives and aids may be added to the ink composition according to the present invention as needed. A resin having both hydrophilic parts and hydrophobic parts may also be used. Examples of the resin having both hydrophilic parts and hydrophobic parts include copolymers of a hydrophilic monomer and a hydrophobic monomer. Examples of the hydrophilic monomer include acrylic acid, methacrylic acid, maleic acid, fumaric acid, monoesters of the carboxylic acids described above, vinylsulfonic acid, styrenesulfonic acid, vinyl alcohol, acrylamide and methacryloxyethyl phosphate. Examples of the hydrophobic monomer include styrene, styrene derivatives such as α-methylstyrene, vinylcyclohexane, vinylnaphthalene derivatives, acrylic acid esters and methacrylic acid esters. It goes without saying that both hydrophilic monomers and hydrophobic monomers are not limited to those described above.

As examples of additives that may be contained in the composition according to the present invention, may be mentioned crosslinking agents, acid generators and polymerization initiators activated by heat or application of electromagnetic waves.

Examples of other additives that can be added to the composition in the present invention include pH adjustors for achieving stabilization of an ink and stability of the ink to pipings in a recording apparatus; penetrants for accelerating penetration of an ink into a recording medium to facilitate apparent drying; mildewproofing agents for preventing occurrence of mildew in an ink; chelating agents for blocking metal ions in an ink to prevent deposition of metals at a nozzle portion and deposition of insoluble matter in the ink; antifoaming agents for preventing occurrence of foam upon circulation, transferring or preparation of a recording liquid; antioxidants, viscosity modifiers; conductivity-imparting agents; and ultraviolet absorbents.

Specific details of an ink composition for ink-jet that is a preferable embodiment of the ink composition according to the present invention will hereinafter be described. The ink composition for ink-jet according to the present invention can be prepared by adding the block polymer and the coloring material to water and a water-soluble solvent, dispersing them by means of a dispersing machine, removing coarse particles by centrifugation or the like, adding water or a solvent and additives or the like and then conducting stirring, mixing and filtration.

Examples of the dispersing machine include ultrasonic homogenizers, laboratory homogenizers, colloid mills, jet mills and ball mills. These machines may be used either singly or in any combination thereof.

The method for applying a liquid according to the present invention will now be described.

(Liquid-Applying Method)

The ink composition according to the present invention can be used in various kinds of image-forming apparatus by various printing methods, ink-jet methods or electrophotographic methods, and pattern-forming apparatus in semiconductor production processes. A drawing can be made by a liquid-applying method using such an apparatus. The ink composition according to the present invention is particularly preferably used in the ink-jet methods. An ink-jet method used may be a well known method such as a piezo ink-jet system using a piezoelectric element or a thermal ink-jet system that thermal energy is applied to an ink to bubble the ink, thereby conducting recording. Either of a continuous type and an On-Demand type may be used. The ink composition according to the present invention may also be used in a recording system that printing is conducted on an intermediate transfer medium with an ink, and an image formed is then transferred to a final recording medium such as paper.

When the ink composition having stimuli responsiveness according to the present invention is used as an ink for ink-jet, it can be used in, for example, such modes as described below. An ink can be aggregated by the following stimuli (a) to (d).

(a) When used as an ink which responds to temperature stimuli

The ink composition for ink-jet according to the present invention causes a phase change by temperature stimuli by a difference between a temperature of the ink composition within an ink tank and a temperature of the ink composition applied on to a recording medium by ejection to rapidly cause viscosity increase or aggregation of insoluble components.

(b) When used as an ink which responds to electromagnetic wave stimuli

Electromagnetic wave stimuli can be given by a method that the interior of an ink tank is provided as a darkroom to expose the ink composition to visible light by ejection or a method that irradiation of electromagnetic waves is conducted by an electromagnetic wave irradiation section provided within an ink-jet recording apparatus. By the electromagnetic wave stimuli, a polymerizable functional group contained in the ink composition according to the present invention is polymerized to cause viscosity increase or aggregation of insoluble components.

(c) When used as an ink which responds to stimuli by pH change

The pH of the ink composition for ink-jet according to the present invention is changed by applying the ink composition to a recording medium to be affected by the recording medium, and the ink composition for ink-jet according to the present invention causes a phase change by this pH change to cause viscosity increase or aggregation of insoluble components.

(d) When used as an ink which responds to stimuli by concentration change

The ink composition for ink-jet according to the present invention causes a phase change by concentration change of the ink composition by a difference between a concentration of the ink composition within an ink tank and a concentration of the ink composition after water and the hydrophilic solvent contained in the ink composition ejected are evaporated or absorbed in a recording medium to cause viscosity increase or aggregation of insoluble components.

By these modifications of ink properties, color bleeding and feathering can be improved, and moreover excellent fixing ability can be developed. Incidentally, the modifications of the ink composition are not limited to the viscosity increase and aggregation of insoluble components described above.

As a method for giving the stimuli, may be applied various methods. A preferable method includes a method that a stimulus-imparting substance, which becomes stimuli, is mixed or contacted with the above-described ink composition having stimuli responsiveness. For example, as a method for mixing a composition having its corresponding pH with the ink composition having pH responsiveness described in the item (c), may be applied by an ink-jet method. As described in Japanese Patent Application Laid-Open No. S64-63185, the stimulus-imparting substance, which becomes stimuli, may be shot throughout the whole region for forming an image by an ink-jet head, or the amount of the stimulus-imparting substance, which becomes stimuli, may be controlled like the method described in Japanese Patent Application Laid-Open No. H8-216392 to form a far excellent image.

The stimulus-imparting substance, which becomes stimuli, may also be combined with an ink containing a dye or pigment. For example, an ink capable of giving stimuli is used as any ink of cyan, magenta, yellow and black (C, M, Y and K) inks used in a color ink-jet method, and an ink having stimuli responsiveness is used as any other ink of the C, M, Y and K inks, whereby color bleeding can be improved. Various combinations become feasible with respect to the condition that any ink of the C, M, Y and K inks is used as an ink having stimuli responsiveness, and any other ink is used as an ink capable of giving stimuli. In the present invention, any combination thereof may be used, and selection of the combination is not limited. As the kinds of the stimulus-imparting composition and the ink having stimuli responsiveness, may be mentioned all the patterns of the above-described response to stimuli, and no particular limitation is imposed on the kinds.

The apparatus for applying a liquid according to the present invention will now be described.

(Liquid-Applying Apparatus)

Ink-jet recording apparatus using the ink composition for ink-jet according to the present invention include ink-jet recording apparatus like a piezo ink-jet system using an piezoelectric element and a Bubble-Jet system that thermal energy is applied to an ink to bubble the ink, thereby conducting recording.

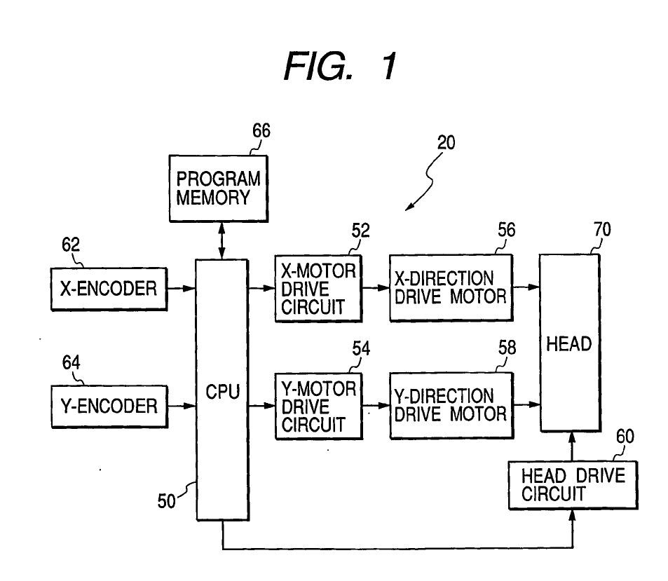

FIG. 1 illustrates a schematic functional diagram of an ink-jet recording apparatus 20. Reference numeral 50 indicates a central processing unit (CPU) of the ink-jet recording apparatus. A program for controlling the CPU 50 may be stored in a program memory 66 or may also be stored in a memory means such as EEPROM (not illustrated) as the so-called firmware. According to the ink-jet recording apparatus, recording data is received from a recording-data-preparing means (not illustrated, computer or the like) to the program memory 66. The recording data may be information itself of images or characters to be recorded, compressed information thereof or encoded information. When the compressed or encoded information is processed, expansion or development can be conducted by the CPU 50 to obtain the information of the images or characters to be recorded. An X-encoder 62 (for example, relating to an X-direction or main scanning direction) and a Y-encoder 64 (for example, relating to a Y-direction or secondary scanning direction) are provided, whereby a relative position of a head to a recording medium can be notified to the CPU 50.

The CPU 50 sends signals for recording the images to an X-motor drive circuit 52, a Y-motor drive circuit 54 and a head drive circuit 60 on the basis of the information of the program memory 66, X-encoder 62 and Y-encoder 64. The X-motor drive circuit 52 and Y-motor drive circuit 54 drive an X-direction drive motor 56 and a Y-direction drive motor 58, respectively, to move a head 70 relatively to the recording medium and to a recording position. The head drive circuit 60 sends signals for conducting ejection of the respective ink compositions (Y, M, C and K) and the stimulus-imparting substance, which becomes stimuli, to the head 70 at the time the head 70 has been moved to the recording position, thereby conducting recording. The head 70 may be a head for ejecting a single ink composition or a head for ejecting plural kinds of ink compositions. The head 70 may have a function for ejecting the stimulus-imparting substance, which becomes stimuli, in combination.

The ink compositions according to the present invention may be used in an apparatus using a direct recording system that an ink is directly applied to a recording medium or may be used in an indirect recording apparatus using, for example, a recording system that an image is formed on an intermediate transfer medium, on which a latent image has been formed, with an ink, and the image is then transferred to a final recording medium such as paper. They may also be applied to an apparatus utilizing an intermediate transfer medium according to the direct recording system.

The recording medium according to the present invention will now be described.

(Recording Medium)

The stimulus-imparting substance, which becomes stimuli, may be mixed or contacted with the ink composition having the stimuli responsiveness as described above. However, a device of giving stimuli may be provided in advance in a recording medium. As examples thereof, may be mentioned a method that an ink having responsiveness to acidity is used as a pH-responsive ink to conduct recording on acid paper; a method that a pH-responsive ink is used as a stimuli-responsive ink to conduct recording on a recording medium which releases a substance capable of changing a pH in response to application of heat, electromagnetic waves or pressure; and a method that a stimuli-responsive ink containing a crosslinkable or polymerizable functional group is used to conduct recording on a recording medium which releases a crosslinking agent or polymerization initiator in response to application of heat, electromagnetic waves or pressure. In the present invention, the recording medium may be in any publicly known form. As examples thereof, may be mentioned plain paper, heat sensitive paper and acid paper.

When the direct recording system is used, the above-described recording medium is used as a final recording medium. When the indirectly recording system is used on the other hand, the above-described recording medium may be used as an intermediate transfer medium or as a final recording medium.

The present invention will hereinafter be described in detail by the following examples. However, the present invention is not limited to these examples.

### EXAMPLE 1

<Synthesis of diblock polymer, poly[IBVE-b-(MOVE-r-C)] composed of isobutyl vinyl ether (IBVE; block A), and 2-methoxyethyl vinyl ether and 4-(2-vinyloxy)ethoxybenzoic acid (MOVE-r-C: block B)> (here, b and r are symbols indicating a block polymer and a random polymer, respectively)

After the interior of a glass container equipped with a three-way stop-cock was purged with nitrogen, the container was heated to 250° C. under a nitrogen gas atmosphere to remove adsorbed water. After the system was returned to room temperature, 24 mmol of IBVE, 16 mmol of ethyl acetate, 0.12 mmol of 1-isobutoxyethyl acetate and 11 ml of toluene were added to cool the reaction system. At the time the temperature within the system had reached 0° C., 0.2 mmol of ethylaluminum sesquichloride (equimolar mixture of diethylaluminum chloride and ethylaluminum chloride) was added to initiate polymerization. The molecular weight was monitored at time division intervals by means of gel permeation column chromatography (GPC) to confirm completion of the polymerization of a block A.

A toluene solution of 8.4 mmol of MOVE and 3.6 mmol of ethyl 4-(2-vinyloxy)ethoxybenzoate as components of a block B was then added to continue the polymerization. After 24 hours, the polymerization reaction was terminated. The termination of the polymerization reaction was conducted by adding a 0.3% by mass aqueous solution of ammonia/methanol into the system. The reaction mixture solution was diluted with dichloromethane and washed three times with 0.6 mol/L hydrochloric acid and then three times with distilled water. The resultant organic phase was concentrated and dried to solids by an evaporator and then vacuum-dried. The resultant product was dialyzed repeatedly in a methanol solvent using a semi-permeable membrane composed of cellulose to remove monomeric compounds, thereby obtaining the intended diblock polymer. The identification of the compound was conducted by means of NMR and GPC. Mn was 25,000, and Mw/Mn was 1.24. The polymerization ratio of A to B was 200:100. The polymerization ratio between the two monomers in the block B was 7:3.

The diblock polymer obtained above was hydrolyzed in a mixed solution of dimethylformamide and aqueous sodium hydroxide, whereby ethyl 4-(2-vinyloxy)ethoxy-benzoate in the block B component was hydrolyzed to obtain a diblock polymer in a form of a sodium salt. The identification of the compound was conducted by means of NMR and GPC.

This polymer was neutralized with 0.1N hydrochloric acid in an aqueous dispersion to obtain a diblock polymer, poly[IBVE-b-(MOVE-r-C)], in which 4-(2-vinyloxy)ethoxy-benzoic acid in the block B component turned into a free carboxylic acid. The identification of the compound was conducted by means of NMR and GPC.

### EXAMPLE 2

Twenty six parts by mass of the block polymer obtained in EXAMPLE 1 and 10 parts by mass of an oil-soluble dye, Oil Blue N (the same as a trade name, product of Aldrich Co.) were dissolved in dimethylformamide, and the resultant solution was converted into a water phase with 400 parts by mass of distilled water to obtain an ink composition. To this ink composition, was added 0.1 ml of a 0.1N aqueous solution of sodium hydroxide, and the mixture was subjected to an ultrasonic homogenizer for 10 minutes and left to stand for 1 hour. The pH of the ink composition was found to be 12 with pH test paper. This dispersion was very transparent and showed a blue color. The oil-soluble dye neither separated nor precipitated even after left to stand for 10 days.

The average particle diameter d and index of degree of dispersion μ/G² of dispersed particles in the dye-dispersed composition obtained by the above-described process were measured by means of a dynamic light-scattering apparatus (DLS-7000, trade name; manufactured by Otsuka Electronics Co., Ltd.). In order not to change the pH, the dispersion was diluted to 1/100 with an aqueous solution of sodium hydroxide of the same concentration to conduct measurement. When the measurement was conducted by means of the dynamic light-scattering apparatus (DLS-7000, trade name; manufactured by Otsuka Electronics Co., Ltd.), the average diameter d was 85 nm, and the index of degree of dispersion μ/G² was 0.09.

### EXAMPLE 3

<Synthesis of diblock polymer, poly[TolOVE-b-(MOEOVE-r-C)] composed of 2-(4-methylbenzeneoxy)ethyl vinyl ether (TolOVE: block A), and diethylene glycol methyl vinyl ether (MOEOVE: block B) and 4-(2-vinyloxy)ethoxybenzoic acid (MOEOVE-r-C: block B)> (here, b and r are symbols indicating a block polymer and a random polymer, respectively)

Synthesis of a diblock polymer, poly[TolOVE-b-(MOEOVE-r-C)] was conducted by using 10.8 mmol of 2-(4-methylbenzeneoxy)ethyl vinyl ether (TolOVE) exhibiting hydrophobicity in place of 24 mmol of IBVE of the component A in EXAMPLE 1 and using diethylene glycol methyl vinyl ether (MOEOVE) in place of 8.4 mmol of 2-methoxyethyl vinyl ether (MOVE) in the component B. The identification of the compound synthesized was conducted by means of GPC and NMR. Mn was 24,100, and Mw/Mn was 1.25. Mn means a number average molecular weight, and Mw denotes a weight average molecular weight. Other synthesizing conditions were the same as those in EXAMPLE 1.

The diblock polymer obtained above was hydrolyzed in a mixed solution of dimethylformamide and aqueous sodium hydroxide, whereby ethyl 4-(2-vinyloxy)ethoxy-benzoate in the block B component was hydrolyzed to obtain a diblock polymer in a form of a sodium salt. The identification of the compound was conducted by means of NMR and GPC.

This polymer was neutralized with 0.1N hydrochloric acid in an aqueous dispersion to obtain a diblock polymer, in which 4-(2-vinyloxy)ethoxybenzoic acid in the block B component turned into a free carboxylic acid. The identification of the compound was conducted by means of NMR and GPC. The polymerization ratio of A to B was 90:100. The polymerization ratio between the two monomers in the block B was 7:3.

### EXAMPLE 4

Twenty six parts by mass of the block polymer obtained in EXAMPLE 3 and 10 parts by mass of an oil-soluble dye, Oil Blue N (the same as a trade name, product of Aldrich Co.) were dissolved in dimethylformamide, and the resultant solution was converted into a water phase with 400 parts by mass of distilled water to obtain an ink composition. To this ink composition, was added 0.1 ml of a 0.1N aqueous solution of sodium hydroxide, and the mixture was subjected to an ultrasonic homogenizer for 10 minutes and left to stand for 1 hour. The pH of the ink composition was found to be 12 with pH test paper. This dispersion was very transparent and showed a blue color. The oil-soluble dye neither separated nor precipitated even after left to stand for 10 days.

The average particle diameter d and index of degree of dispersion μ/G² of dispersed particles in the dye-dispersed composition obtained by the above-described process were measured by means of a dynamic light-scattering apparatus (DLS-7000, trade name; manufactured by Otsuka Electronics Co., Ltd.). In order not to change the pH, the dispersion was diluted to 1/100 with an aqueous solution of sodium hydroxide of the same concentration to conduct measurement. The average diameter d was 82 nm, and the index of degree of dispersion μ/G² was 0.09.

### EXAMPLE 5

<Synthesis of diblock polymer, poly[PhOVE-b-(MOEOVE-r-C)] composed of 2-phenoxyethyl vinyl ether (PhOVE: block A), and diethylene glycol methyl vinyl ether (MOEOVE: block B) and 4-(2-vinyloxy)ethoxybenzoic acid (MOEOVE-r-C: block B)> (here, b and r are symbols indicating a block polymer and a random polymer, respectively)

Synthesis of a diblock polymer, poly[PhOVE-b-(MOEOVE-r-C)] was conducted by using 12 mmol of 2-phenoxyethyl vinyl ether (PhOVE) exhibiting hydrophobicity in place of 24 mmol of IBVE of the component A in EXAMPLE 1 and using diethylene glycol methyl vinyl ether (MOEOVE) in place of 8.4 mmol of 2-methoxyethyl vinyl ether (MOVE) in the component B. The identification of the compound synthesized was conducted by means of GPC and NMR. Mn was 24,500, and Mw/Mn was 1.25. Mn means a number average molecular weight, and Mw denotes a weight average molecular weight. Other synthesizing conditions were the same as those in EXAMPLE 1.

The diblock polymer obtained above was hydrolyzed in a mixed solution of dimethylformamide and aqueous sodium hydroxide, whereby ethyl 4-(2-vinyloxy)ethoxy-benzoate in the block B component was hydrolyzed to obtain a diblock polymer in a form of a sodium salt. The identification of the compound was conducted by means of NMR and GPC.

This polymer was neutralized with 0.1N hydrochloric acid in an aqueous dispersion to obtain a diblock polymer, in which 4-(2-vinyloxy)ethoxybenzoic acid in the block B component turned into a free carboxylic acid. The identification of the compound was conducted by means of NMR and GPC. The polymerization ratio of A to B was 100:100. The polymerization ratio between the two monomers in the block B was 7:3.

### EXAMPLE 6

Twenty six parts by mass of the block polymer obtained in EXAMPLE 5 and 10 parts by mass of an oil-soluble dye, Oil Blue N (the same as a trade name, product of Aldrich Co.) were dissolved in dimethylformamide, and the resultant solution was converted into a water phase with 400 parts by mass of distilled water to obtain an ink composition. To this ink composition, was added 0.1 ml of a 0.1N aqueous solution of sodium hydroxide, and the mixture was subjected to an ultrasonic homogenizer for 10 minutes and left to stand for 1 hour. The pH of the ink composition was found to be 12 with pH test paper. This dispersion was very transparent and showed a blue color. The oil-soluble dye neither separated nor precipitated even after left to stand for 10 days.

The average particle diameter d and index of degree of dispersion μ/G² of dispersed particles in the dye-dispersed composition obtained by the above-described process were measured by means of a dynamic light-scattering apparatus (DLS-7000, trade name; manufactured by Otsuka Electronics Co., Ltd.). In order not to change the pH, the dispersion was diluted to 1/100 with an aqueous solution of sodium hydroxide of the same concentration to conduct measurement. The average diameter d was 83 nm, and the index of degree of dispersion μ/G² was 0.09.

### EXAMPLE 7

<Synthesis of diblock polymer, poly[TolOVE-b-(MOEOEOVE-r-C)] composed of 2-(4-methylbenzeneoxy)ethyl vinyl ether (TolOVE: block A), and triethylene glycol methyl vinyl ether (MOEOEOVE: block B) and 4-(2-vinyloxy)ethoxybenzoic acid (MOEOEOVE-r-C: block B)> (here, b and r are symbols indicating a block polymer and a random polymer, respectively)

Synthesis of a diblock polymer, poly[TolOVE-b-(MOEOEOVE-r-C)] was conducted by using 10.8 mmol of 2-(4-methylbenzeneoxy)ethyl vinyl ether (TolOVE) exhibiting hydrophobicity in place of 24 mmol of IBVE of the component A in EXAMPLE 1 and using triethylene glycol methyl vinyl ether (MOEOEOVE) in place of 8.4 mmol of 2-methoxyethyl vinyl ether (MOVE) in the component B. The identification of the compound synthesized was conducted by means of GPC and NMR. Mn was 27,200, and Mw/Mn was 1.26. Mn means a number average molecular weight, and Mw denotes a weight average molecular weight. Other synthesizing conditions were the same as those in EXAMPLE 1.

The diblock polymer obtained above was hydrolyzed in a mixed solution of dimethylformamide and aqueous sodium hydroxide, whereby ethyl 4-(2-vinyloxy)ethoxy-benzoate in the block B component was hydrolyzed to obtain a diblock polymer in a form of a sodium salt. The identification of the compound was conducted by means of NMR and GPC.

This polymer was neutralized with 0.1N hydrochloric acid in an aqueous dispersion to obtain a diblock polymer, in which 4-(2-vinyloxy)ethoxybenzoic acid in the block B component turned into a free carboxylic acid. The identification of the compound was conducted by means of NMR and GPC. The polymerization ratio of A to B was 90:100. The polymerization ratio between the two onomers in the block B was 7:3.

### EXAMPLE 8

Twenty six parts by mass of the block polymer obtained in EXAMPLE 7 and 10 parts by mass of an oil-soluble dye, Oil Blue N (the same as a trade name, product of Aldrich Co.) were dissolved in dimethylformamide, and the resultant solution was converted into a water phase with 400 parts by mass of distilled water to obtain an ink composition. To this ink composition, was added 0.1 ml of a 0.1N aqueous solution of sodium hydroxide, and the mixture was subjected to an ultrasonic homogenizer for 10 minutes and left to stand for 1 hour. The pH of the ink composition was found to be 12 with pH test paper. This dispersion was very transparent and showed a blue color. The oil-soluble dye neither separated nor precipitated even after left to stand for 10 days.

The average particle diameter d and index of degree of dispersion μ/G² of dispersed particles in the dye-dispersed composition obtained by the above-described process were measured by means of a dynamic light-scattering apparatus (DLS-7000, trade name; manufactured by Otsuka Electronics Co., Ltd.). In order not to change the pH, the dispersion was diluted to 1/100 with an aqueous solution of sodium hydroxide of the same concentration to conduct measurement. The average diameter d was 86 nm, and the index of degree of dispersion μ/G² was 0.09.

### EXAMPLE 9

<Synthesis of triblock polymer, poly[TolOVE-b-MOEOVE-b-(MOEOVE-r-C)] composed of 2-(4-methylbenzeneoxy)ethyl vinyl ether (TolOVE: block A), diethylene glycol methyl vinyl ether (MOEOVE: block B), and diethylene glycol methyl vinyl ether and 4-(2-vinyloxy)ethoxybenzoic acid (MOEOVE-r-C: block C)> (here, b and r are symbols indicating a block polymer and a random polymer, respectively)

After the interior of a glass container equipped with a three-way stop-cock was purged with nitrogen, the container was heated to 250° C. under a nitrogen gas atmosphere to remove adsorbed water. After the system was returned to room temperature, 10.8 mmol of 2-(4-methylbenzeneoxy)ethyl vinyl ether (TolOVE), 16 mmol of ethyl acetate, 0.12 mmol of 1-isobutoxyethyl acetate and 11 ml of toluene were added to cool the reaction system. At the time the temperature within the system had reached 0° C., 0.2 mmol of ethylaluminum sesquichloride (equimolar mixture of diethylaluminum chloride and ethylaluminum chloride) was added to initiate polymerization. A molecular weight was monitored at time division intervals by means of gel permeation column chromatography (GPC) to confirm completion of the polymerization of a block A.

Then, 6.0 mmol of MOEOVE as a component of a block B was added to continue the polymerization. Completion of the polymerization of a block B was confirmed by monitoring by means of GPC.

A toluene solution of 8.4 mmol of MOEOVE and 3.6 mmol of ethyl 4-(2-vinyloxy)ethoxybenzoate as components of a block C was then added to continue the polymerization. After 24 hours, the polymerization reaction was terminated. The termination of the polymerization reaction was conducted by adding a 0.3% by mass aqueous solution of ammonia/methanol into the system. The reaction mixture solution was diluted with dichloromethane and washed three times with 0.6 mol/L hydrochloric acid and then three times with distilled water. The resultant organic phase was concentrated and dried to solids by an evaporator and then vacuum-dried. The resultant product was dialyzed repeatedly in a methanol solvent using a semi-permeable membrane composed of cellulose to remove monomeric compounds, thereby obtaining the intended triblock polymer. The identification of the compound was conducted by means of NMR and GPC. Mn was 34,500, and Mw/Mn was 1.25. The polymerization ratio of A to B to C was 90:50:100. The polymerization ratio between the two monomers in the block C was 7:3.

The triblock polymer obtained above was hydrolyzed in a mixed solution of dimethylformamide and aqueous sodium hydroxide, whereby ethyl 4-(2-vinyloxy)ethoxy-benzoate in the block C component was hydrolyzed to obtain a triblock polymer in a form of a sodium salt. The identification of the compound was conducted by means of NMR and GPC.

This polymer was neutralized with 0.1N hydrochloric acid in an aqueous dispersion to obtain a triblock polymer, in which 4-(2-vinyloxy)ethoxybenzoic acid in the block C component turned into a free carboxylic acid. The identification of the compound was conducted by means of NMR and GPC.

### EXAMPLE 10

Twenty six parts by mass of the block polymer obtained in EXAMPLE 9 and 10 parts by mass of an oil-soluble dye, Oil Blue N (the same as a trade name, product of Aldrich Co.) were dissolved in dimethylformamide, and the resultant solution was converted into a water phase with 400 parts by mass of distilled water to obtain an ink composition. To this ink composition, was added 0.1 ml of a 0.1N aqueous solution of sodium hydroxide, and the mixture was subjected to an ultrasonic homogenizer for 10 minutes and left to stand for 1 hour. The pH of the ink composition was found to be 12 with pH test paper. This dispersion was very transparent and showed a blue color. The oil-soluble dye neither separated nor precipitated even after left to stand for 10 days.

The average particle diameter d and index of degree of dispersion μ/G² of dispersed particles in the dye-dispersed composition obtained by the above-described process were measured by means of a dynamic light-scattering apparatus (DLS-7000, trade name; manufactured by Otsuka Electronics Co., Ltd.). In order not to change the pH, the dispersion was diluted to 1/100 with an aqueous solution of sodium hydroxide of the same concentration to conduct measurement. The average diameter d was 89 nm, and the index of degree of dispersion μ/G² was 0.09.

### COMPARATIVE EXAMPLE 1

A diblock copolymer (number average molecular weight: 10,600, number average molecular weight ratio: 36:70) of styrene and ethylene oxide and Oil Blue N as an oil-soluble dye were used to prepare a dispersed ink in accordance with the same operation process as in EXAMPLE 2. The dispersed ink showed a blue color, but a heavy turbid state was observed. The average diameter d was 312 nm, and the index of degree of dispersion β/G² was 0.9. When the ink was left to stand for 10 days, the oil-soluble dye partially separated and precipitated.

### COMPARATIVE EXAMPLE 2

The dispersion obtained in COMPARATIVE EXAMPLE 1 was centrifuged to recover supernatants. The average particle diameters d and indexes of degree of dispersion p/G² of three supernatants (Liquid A, Liquid B and Liquid C) in order from the top were 235 nm and 0.44 for Liquid A, 285 nm and 0.52 for Liquid B, and 432 nm and 0.65 for Liquid C. In any supernatant, a turbid state was clearly observed.

The ink composition of EXAMPLE 2 was scarcely turbid, while Liquid A was clearly observed being in a heavily turbid state.

### EXAMPLE 11

The ink compositions of EXAMPLE 2, EXAMPLE 4, EXAMPLE 6, EXAMPLE 8 and EXAMPLE 10, and Liquid A, Liquid B and Liquid C of COMPARATIVE EXAMPLE 2 were separately diluted to 1/50 to measure their transmittances at a wavelength of 500 nm by means of a turbidimeter (manufactured by Youngwoo Instruments Co.). In other words, a higher transmittance indicates that such a composition or liquid showed a brighter color. The transmittances of the dispersed ink compositions of EXAMPLE 2, EXAMPLE 4, EXAMPLE 6, EXAMPLE 8 and EXAMPLE 10, and Liquid A, Liquid B and Liquid C of COMPARATIVE EXAMPLE 2 were respectively 44%, 46%, 46%, 44%, 42%, 25%, 23% and 21% in that order.

### EXAMPLE 12

A block polymer having 2-ethoxyethyl vinyl ether (EOVE) exhibiting hydrophilicity at a temperature lower than 20° C. and hydrophobicity at a temperature not lower than 20° C. as the component A (IBVE) of the block polymer obtained in EXAMPLE 1 was obtained by using 12 mmol of EOVE in place of 12 mmol of IBVE in EXAMPLE 1. Other synthesizing conditions were the same as those in EXAMPLE 1. The identification of the compound synthesized was conducted by means of GPC and NMR. Mn was 28,200, and Mw/Mn was 1.18. Mn means a number average molecular weight, and Mw denotes a weight average molecular weight.

Twenty six parts by mass of the diblock polymer thus obtained and 10 parts by mass of an oil-soluble dye, Oil Blue N (the same as a trade name, product of Aldrich Co.) were dissolved in dimethylformamide, and the resultant solution was converted into a water phase with 400 parts by mass of distilled water to obtain an ink composition. The oil-soluble dye neither separated nor precipitated even after left to stand for 10 days.

The average particle diameter d and index of degree of dispersion μ/G² of dispersed particles in the dye-dispersed composition obtained by the above-described process were measured by means of a dynamic light-scattering apparatus (DLS-7000, trade name; manufactured by Otsuka Electronics Co., Ltd.). In order not to change the pH, the dispersion was diluted to 1/100 with an aqueous solution of sodium hydroxide of the same concentration to conduct measurement. The average diameter d was 95 nm, and the index of degree of dispersion μ/G² was 0.09.

This dye-dispersed composition was cooled to 10° C. to collapse the polymer micelle to dissolve the polymer in water. As a result, the dye and the dye solution were separated from each other, and the water layer became colorless. From this result, it was confirmed that the coloring material was included.

### EXAMPLE 13

2-Ethoxyethyl vinyl ether (EOVE) exhibiting hydrophilicity at a temperature not higher than 20° C. and hydrophobicity at a temperature higher than 20° C. (upper limit temperature required for hydration) was used in an equimolar amount in place of the monomer of the component A in each of EXAMPLE 3, EXAMPLE 5, EXAMPLE 7 and EXAMPLE 9 to conduct syntheses of a diblock polymer, poly[EOVE-b-(MOEOVE-r-C)], a diblock polymer, poly[EOVE-b-(MOEOVE-r-C)], a diblock polymer, poly[EOVE-b-(MOEOEOVE-r-C)] and a triblock polymer, poly[EOVE-MOEOVE-b-(MOEOVE-r-C)] in order of EXAMPLE 3, EXAMPLE 5, EXAMPLE 7 and EXAMPLE 9. The identification of the compounds synthesized was conducted by means of GPC and NMR. The number average molecular weights Mn were 18,500, 19,700, 21,600 and 28,900 in order of EXAMPLE 3, EXAMPLE 5, EXAMPLE 7 and EXAMPLE 9, and ratios of Mw/Mn were 1.20, 1.20, 1.22 and 1.22. Mn means a number average molecular weight, and Mw denotes a weight average molecular weight. The upper limit temperature required for hydration of EOVE was measured by synthesizing a homo(EOVE) in the same manner as in EXAMPLE 1. Other synthesizing conditions were respectively the same as those in EXAMPLE 3, EXAMPLE 5, EXAMPLE 7 and EXAMPLE 9.

Twenty six parts by mass of each of the diblock and triblock polymers thus obtained and 10 parts by mass of an oil-soluble dye, Oil Blue N (the same as a trade name, product of Aldrich Co.) were dissolved in dimethylformamide, and the resultant solution was converted into a water phase with 400 parts by mass of distilled water to obtain ink compositions. The oil-soluble dyes in all the ink compositions neither separated nor precipitated even after left to stand for 10 days.

The average particle diameters d and indexes of degree of dispersion μ/G² of dispersed particles in the dye-dispersed compositions obtained by the above-described process were measured by means of a dynamic light-scattering apparatus (DLS-7000, trade name; manufactured by Otsuka Electronics Co., Ltd.). In order not to change the pH, each of the dispersions was diluted to 1/100 with an aqueous solution of sodium hydroxide of the same concentration to conduct measurement. The average diameters d were 92 nm, 93 nm, 96 nm and 99 nm in order of EXAMPLE 3, EXAMPLE 5, EXAMPLE 7 and EXAMPLE 9, and the indexes of degree of dispersion β/G² were 0.09, 0.09, 0.09 and 0.09.

These dye-dispersed compositions were separately cooled to 10° C. to collapse their polymer micelles to dissolve the polymers in water. As a result, the dye and the dye solution were separated from each other in all the dye-dispersed compositions, and the water layers became colorless. From this result, it was confirmed that the coloring material was included.

### EXAMPLE 14

The ink compositions prepared by selecting Oil Blue N as the oil-soluble dye in EXAMPLE 2, EXAMPLE 4, EXAMPLE 6, EXAMPLE 8 and EXAMPLE 10 were used to make evaluation as to fixing strength. Each of the ink compositions was charged in a printing head of an ink-jet printer (BJF 800, trade name, manufactured by Canon Inc.) to conduct recording on plain paper by means of the ink-jet printer.

In the recording using the ink compositions respectively prepared in EXAMPLE 2, EXAMPLE 4, EXAMPLE 6, EXAMPLE 8 and EXAMPLE 10, a 5% by weight aqueous solution of polyacrylic acid having a pH of 2 was first ejected on plain paper that is a recording medium, thereby preparing a recording medium capable of giving stimuli. Ink-jet recording was conducted on this recording medium. After 30 seconds, a recorded area was strongly pushed with a finger. As a result, no ink adhered to the finger in each case.

When each of the ink compositions was mixed with a 5% by weight aqueous solution of polyacrylic acid having a pH of 2, blue gel was rapidly formed.

### EXAMPLE 15

<Synthesis of diblock polymer, poly[(IBVE-r-VEEtPhPh)-b-(MOEOVE-r-C)] composed of isobutyl vinyl ether and biphenyloxyethyl vinyl ether (IBVE-r-VEEtPhPh; block A), and diethylene glycol methyl vinyl ether and ethyl 4-(2-vinyloxy)ethoxybenzoate (MOEOVE-r-C: block B)> (here, b and r are symbols indicating a block polymer and a random polymer, respectively)

After the interior of a glass container equipped with a three-way stop-cock was purged with nitrogen, the container was heated to 250° C. under a nitrogen gas atmosphere to remove adsorbed water. After the system was returned to room temperature, 6 mmol of IBVE, 6 mmol of VEEtPhPh, 16 mmol of ethyl acetate, 0.1 mmol of 1-isobutoxyethyl acetate and 11 ml of toluene were added to cool the reaction system. At the time the temperature within the system had reached 0° C., 0.2 mmol of ethylaluminum sesquichloride (equimolar mixture of diethylaluminum chloride and ethylaluminum chloride) was added to initiate polymerization. The molecular weight was monitored at time division intervals by means of gel permeation column chromatography (GPC) to confirm completion of the polymerization of a block A.

After 7.2 mmol of ethyl 4-(2-vinyloxy)ethoxy-benzoate was then added as a component of a block B, a toluene solution of 4.8 mmol of MOEOVE was continuously added in the process of the living polymerization of ethyl 4-(2-vinyloxy)ethoxybenzoate to continue the polymerization. Completion of the polymerization of a block B was confirmed by monitoring at time sharing by means of gel permeation column chromatography (GPC). The termination of the polymerization reaction was conducted by adding a 0.3% by mass aqueous solution of ammonia/methanol into the system. The reaction mixture solution was diluted with dichloromethane and washed three times with 0.6 mol/L hydrochloric acid and then three times with distilled water. The resultant organic phase was concentrated and dried to solids by an evaporator and then vacuum-dried. The resultant product was dialyzed repeatedly in a methanol solvent using a semi-permeable membrane composed of cellulose to remove monomeric compounds, thereby obtaining the intended diblock polymer. The identification of the compound was conducted by means of NMR and GPC in the same manner as described above. Mn was 31,000, and Mw/Mn was 1.32. The polymerization ratio of A to B was 100:100. The polymerization ratio between the two monomers in the block A was 40:60 in terms of the ratio of MOEOVE to ethyl 4-(2-vinyloxy)ethoxybenzoate.

Further, polymerization was conducted by changing the amounts of MOEOVE and ethyl 4-(2-vinyloxy)ethoxy-benzoate added as components of the block B to 6.0 mmol/6.0 mmol, 8.4 mmol/3.6 mmol, 10.8 mmol/1.2 mmol and 12.0 mmol/0 mmol (MOEOVE/ethyl 4-(2-vinyloxy)ethoxy-benzoate). Other synthesizing conditions were the same as those described above. The identification of the compounds thus obtained was conducted by means of GPC and NMR. As a result, Mn was 30,100, and Mw/Mn was 1.33 in the case where the amounts of MOEOVE and ethyl 4-(2-vinyloxy)ethoxy-benzoate added were 6.0 mmol and 6.0 mmol, Mn was 28,300, and Mw/Mn was 1.35 in the case where the amounts were 8.4 mmol and 3.6 mmol, Mn was 26,500, and Mw/Mn was 1.36 in the case where the amounts were 10.8 mmol and 1.2 mmol, and Mn was 28,300, and Mw/Mn was 1.35 in the case where the amounts were 12.0 mmol and 0 mmol. The polymerization ratio of A to B was 100:100 in each case. Polymerization ratios between the two monomers in the blocks B were 50:50, 70/30, 90/10 and 100/0 (MOEOVE/ethyl 4-(2-vinyloxy)ethoxybenzoate) in order.

Twenty six parts by mass of each of the diblock polymers thus obtained and 10 parts by mass of an oil-soluble dye, Oil Blue N (the same as a trade name, product of Aldrich Co.) were dissolved in dimethylformamide, and the resultant solution was converted into a water phase with 400 parts by mass of distilled water to obtain ink compositions. The oil-soluble dyes in all the ink compositions neither separated nor precipitated even after left to stand for 10 days.

The average particle diameters d and indexes of degree of dispersion μ/G² of dispersed particles in the dye-dispersed compositions obtained by the above-described process were measured by means of a dynamic light-scattering apparatus (DLS-7000, trade name; manufactured by Otsuka Electronics Co., Ltd.). In order not to change the pH, each of the dispersions was diluted to 1/100 with an aqueous solution of sodium hydroxide of the same concentration to conduct measurement. The average diameters d were 85.0 nm, 85.4 nm, 85.6 nm, 86.0 and 98.0 nm in order of the polymerization ratios between the two monomers in the blocks B of 40/60, 50/50, 70/30, 90/10 and 100/0 (MOEOVE/ethyl 4-(2-vinyloxy)ethoxy-benzoate), and the indexes of degree of dispersion μ/G² were 0.09, 0.09, 0.08, 0.08, and 0.08.

These dye-dispersed compositions were separately cooled to 10° C. to collapse their polymer micelles to dissolve the polymers in water. As a result, the dye and the dye solution were separated from each other in all the dye-dispersed compositions, and the water layers became colorless. From this result, it was confirmed that the coloring material was included.

### EXAMPLE 16

<Synthesis of diblock polymer, poly[(IBVE-r-VEEtPhPh)-b-(MOEOEOVE-r-C)] composed of isobutyl vinyl ether and biphenyloxyethyl vinyl ether (IBVE-r-VEEtPhPh; block A), and triethylene glycol methyl vinyl ether and ethyl 4-(2-vinyloxy)ethoxybenzoate (MOEOEOVE-r-C: block B)> (here, b and r are symbols indicating a block polymer and a random polymer, respectively)

Synthesis of diblock polymer, poly[(IBVE-r-VEEtPhPh)-b-(MOEOEOVE-r-C)] was conducted by using triethylene glycol methyl vinyl ether (MOEOEOVE) in place of the monomer, MOEOVE of the block B component in EXAMPLE 15.

The polymerization was conducted by changing the amounts of MOEOEOVE and ethyl 4-(2-vinyloxy)ethoxy-benzoate added as components of the block B to 5 combinations of 4.8 mmol/7.2 mmol, 6.0 mmol/6.0 mmol, 8.4 mmol/3.6 mmol, 10.8 mmol/1.2 mmol and 12.0 mmol/0 mmol (MOEOVE/ethyl 4-(2-vinyloxy)ethoxy-benzoate). The identification of the compounds thus synthesized was conducted by means of GPC and NMR. As a result, Mn was 32,900, and Mw/Mn was 1.25 in the case where the amounts of MOEOEOVE and ethyl 4-(2-vinyloxy)ethoxy-benzoate added were 4.8 mmol and 7.2 mmol, Mn was 32,400, and Mw/Mn was 1.25 in the case where the amounts were 6.0 mmol and 6.0 mmol, Mn was 31,500, and Mw/Mn was 1.27 in the case where the amounts were 8.4 mmol and 3.6 mmol, Mn was 30,600, and Mw/Mn was 1.28 in the case where the amounts were 10.8 mmol and 1.2 mmol, and Mn was 30,100, and Mw/Mn was 1.28 in the case where the amounts were 12.0 mmol and 0 mmol. The polymerization ratio of A to B was 100:100 in each case. Polymerization ratios between the tw6 monomers in the blocks B were 40/60, 50/50, 70/30, 90/10 and 100/0 (MOEOEOVE/ethyl 4-(2-vinyloxy)ethoxybenzoate) in order.

Twenty six parts by mass of each of the diblock polymers thus obtained and 10 parts by mass of an oil-soluble dye, Oil Blue N (the same as a trade name, product of Aldrich Co.) were dissolved in dimethylformamide, and the resultant solution was converted into a water phase with 400 parts by mass of distilled water to obtain ink compositions. The oil-soluble dyes in all the ink compositions neither separated nor precipitated even after left to stand for 10 days.

The average particle diameters d and indexes of degree of dispersion. μ/G² of dispersed particles in the dye-dispersed compositions obtained by the above-described process were measured by means of a dynamic light-scattering apparatus (DLS-7000, trade name; manufactured by Otsuka Electronics Co., Ltd.). In order not to change the pH, each of the dispersions was diluted to 1/100 with an aqueous solution of sodium hydroxide of the same concentration to conduct measurement. The average diameters d were 85.3 nm, 86.1 nm, 86.6 nm, 87.2 and 98.6 nm in order of the polymerization ratios between the two monomers in the blocks B of 40/60, 50/50, 70/30, 90/10 and 100/0 (MOEOVE/ethyl 4-(2-vinyloxy)ethoxy-benzoate), and the indexes of degree of dispersion μ/G² were 0.09, 0.09, 0.08, 0.08 and 0.07.

### EXAMPLE 17

2-Ethoxyethyl vinyl ether (EOVE) exhibiting hydrophilicity at a temperature not higher than 20° C. and hydrophobicity at a temperature higher than 20° C. (upper limit temperature required for hydration) was used in an amount of 12 mmol in place of the monomers, IBVE and VEEtPhPh of the component A in each of EXAMPLE 15 and EXAMPLE 16 to conduct syntheses of a diblock polymer, poly[EOVE-b-(MOEOVE-r-C)] and a diblock polymer, poly[EOVE-b-(MOEOEOVE-r-C)] in order of EXAMPLE 15 and EXAMPLE 16.

Twenty six parts by mass of each of the diblock polymers thus obtained and 10 parts by mass of an oil-soluble dye, Oil Blue N (the same as a trade name, product of Aldrich Co.) were dissolved in dimethylformamide, and the resultant solution was converted into a water phase with 400 parts by mass of distilled water to obtain ink compositions. The oil-soluble dyes in all the ink compositions neither separated nor precipitated even after left to stand for 10 days.

These dye-dispersed compositions were separately cooled to 10° C. to collapse their polymer micelles to dissolve the polymers in water. As a result, the dye and the dye solution were separated from each other in all the dye-dispersed compositions, and the water layers became colorless. From this result, it was confirmed that the coloring material was included.

### EXAMPLE 18

Each of the ink compositions obtained in EXAMPLE 15 and EXAMPLE 16 was charged in a printing head of an ink-jet printer (BJF 800, trade name, manufactured by Canon Inc.) to continuously conduct solid printing of a square of 50 mm×50 mm for 3 minutes. Thereafter, the printer was left to stand for 10 minutes without capping, and solid printing of a square of 50 mm×50 mm was then conducted again. At this time, the proportion of blur, defect and the like of an image formed was evaluated in accordance with the following standard.
⊚: None of blur and defect were observed;
◯: Proportion of blur and defect to the whole square of 50 mm×50 mm was lower than 5%;
Δ: Proportion of blur and defect to the whole square of 50 mm×50 mm was not lower than 5%, and lower than 30%;
x: Proportion of blur and defect to the whole square of 50 mm×50 mm was not lower than 30%.

The evaluation was made on the ink compositions obtained in EXAMPLE 15. As a result, the evaluated results were ◯, ⊚, ⊚ and ◯ in order of the polymerization ratios between the two monomers in the blocks B of 40/60, 50/50, 70/30, 90/10 and 100/0 (MOEOVE/ethyl 4-(2-vinyloxy)ethoxy-benzoate.

The evaluation was made on the ink compositions obtained in EXAMPLE 16. As a result, the evaluated results were ◯, ⊚, ⊚, ⊚ and ◯ in order of the polymerization ratios between the two monomers in the blocks B of 40/60, 50/50, 70/30, 90/10 and 100/0 (MOEOEOVE/ethyl 4-(2-vinyloxy)ethoxy-benzoate.

### EXAMPLE 19

Each of the ink compositions obtained in EXAMPLE 15 and EXAMPLE 16 was charged in a printing head of an ink-jet printer (BJF 800, trade name, manufactured by Canon Inc.) to conduct solid printing of a square of 50 mm×50 mm. Plain paper sprayed with hydrochloric acid was used as recording media to prepare recording media capable of giving stimuli. After 30 seconds from completion of the printing, an image formed was rubbed prescribed times with a line marker to contact observation of a smeared image trailing edge in accordance with the following standard, thereby evaluating the ink compositions as to fixing ability.
⊚: No blue smeared image trailing edge was observed even when strongly rubbed up to 5 times with a line marker;
◯: No blue smeared image trailing edge was observed even when strongly rubbed up to 3 times with a line marker;
Δ: No blue smeared image trailing edge was observed even when strongly rubbed up to 2 times with a line marker;
x: A blue smeared image trailing edge was observed when strongly rubbed once with a line marker.

The evaluation was made on the ink compositions obtained in EXAMPLE 15. As a result, the evaluated results were ◯, ◯, ◯, ⊚ and Δ in order of the polymerization ratios between the two monomers in the blocks B of 40/60, 50/50, 70/30, 90/10 and 100/0 (MOEOVE/ethyl 4-(2-vinyloxy)ethoxy-benzoate.

The evaluation was made on the ink compositions obtained in EXAMPLE 16. As a result, the evaluated results were ◯, ◯, ◯, ⊚ and Δ in order of the polymerization ratios between the two monomers in the blocks B of 40/60, 50/50, 70/30, 90/10 and 100/0 (MOEOEOVE/ethyl 4-(2-vinyloxy)ethoxy-benzoate.

### EXAMPLE 20

<Synthesis of diblock polymer, poly[(IBVE-r-BPhOVE)-b-(MOVE-g-C)] composed of isobutyl vinyl ether and CH₂═CHOCH₂OPhPh (IBVE-r-BPhOVE; block A), and 2-methoxyethyl vinyl ether and 4-(2-vinyloxy)ethoxybenzoic acid (MOVE-g-C: block B)> (here, r, b and g are symbols indicating a random polymer, a block polymer and a gradient polymer, respectively)

After the interior of a glass container equipped with a three-way stop-cock was purged with nitrogen, the container was heated to 250° C. under a nitrogen gas atmosphere to remove adsorbed water. After the system was returned to room temperature, 6 mmol of IBVE, 6 mmol of BPhOVE, 16 nmol of ethyl acetate, 0.1 mmol of 1-isobutoxyethyl acetate and 11 ml of toluene were added to cool the reaction system. At the time the temperature within the system had reached 0° C., 0.2 mmol of ethylaluminum sesquichloride (equimolar mixture of diethylaluminum chloride and ethylaluminum chloride) was added to initiate polymerization. The molecular weight was monitored at time division intervals by means of gel permeation column chromatography (GPC) to confirm completion of the polymerization of a block A.

After 8.4 mmol of MOVE was then added as a component of a block B, a toluene solution of 3.6 mmol of ethyl 4-(2-vinyloxy)ethoxybenzoate was continuously added in the process of the living polymerization of MOVE to continue the polymerization. After 24 hours, the polymerization was terminated. The termination of the polymerization reaction was conducted by adding a 0.3% by mass aqueous solution of ammonia/methanol into the system. The reaction mixture solution was diluted with dichloromethane and washed three times with 0.6 mol/L hydrochloric acid and then three times with distilled water. The resultant organic phase was concentrated and dried to solids by an evaporator and then vacuum-dried. The resultant product was dialyzed repeatedly in a methanol solvent using a semi-permeable membrane composed of cellulose to remove monomeric compounds, thereby obtaining the intended diblock polymer.

The identification of the compound was conducted by means of NMR and GPC. Mn was 23,000, and Mw/Mn was 1.24. The polymerization ratio of A to B was 100:100. The polymerization ratio between the two monomers in the block A was 1:1.

NMR measurement as to a polymer formed at each reaction time in the process of the polymerization of the block B was conducted. As a result, it was found that the proportion of the repeating unit structure of ethyl 4-(2-vinyloxy)ethoxy-benzoate to MOVE increased as the polymerization progressed. It was thus confirmed that a block polymer, in which the monomer composition gradually changes along the polymer chain, was synthesized. The polymerization ratio between the two monomers in the block B of the block polymer obtained finally was 70:30, i.e., 7:3.

The diblock polymer obtained above was hydrolyzed in a mixed solution of dimethylformamide and aqueous sodium hydroxide, whereby ethyl 4-(2-vinyloxy)ethoxy-benzoate in the block B component was hydrolyzed to obtain a diblock polymer in a form of a sodium salt, i.e., a diblock polymer, in which the proportion of a repeating unit structure exhibiting anionicity in a hydrophilic block segment increases along the polymer chain as it becomes closer to a growing terminal. The identification of the compound was conducted by means of NMR and GPC.

This polymer was neutralized with 0.1N hydrochloric acid in an aqueous dispersion to obtain a diblock polymer, poly[(IBVE-r-BPhOVE)-b-(MOVE-g-C)], in which 4-(2-vinyloxy)ethoxybenzoic acid in the block B component turned into a free carboxylic acid. The identification of the compound was conducted by means of NMR and GPC.

### EXAMPLE 21

Thirteen parts by mass of the block polymer obtained in EXAMPLE 20 and 5 parts by mass of an oil-soluble dye, Oil Blue N (the same as a trade name, product of Aldrich Co.) were dissolved in dimethylformamide, and the resultant solution was converted into a water phase with 400 parts by mass of distilled water to obtain an ink composition. To this ink composition, was added 0.1 ml of a 0.1N aqueous solution of sodium hydroxide, and the mixture was subjected to an ultrasonic homogenizer for 10 minutes and left to stand for 1 hour. The pH of the ink composition was found to be 12 with pH test paper. This dispersion was very transparent and showed a blue color. The oil-soluble dye neither separated nor precipitated even after left to stand for 10 days.

The ink composition obtained above was charged in a printing head of an ink-jet printer (BJF 800, trade name, manufactured by Canon Inc.) and ejected on a recording medium, thereby obtaining an image. After 30 seconds from completion of the ink-jet recording, a recorded area was strongly pushed with a finger. As a result, no ink adhered to the finger.

### EXAMPLE 22

The ink composition obtained in EXAMPLE 21 was charged in a printing head of an ink-jet printer (BJF 800, trade name, manufactured by Canon Inc.) and ejected on a recording medium, thereby obtaining an image. Plain paper sprayed with hydrochloric acid was used as recording media to prepare recording media capable of giving stimuli. The recording media and the dispersed composition were evaluated by the following methods (1) and (2).

(1) Solid printing of a square of 50 mm×50 mm was conducted by the above-described printer. After 30 seconds from completion of the printing, a recorded area was strongly pushed with a finger. As a result, no ink adhered to the finger.

(2) Solid printing of a square of 50 mm×50 mm was conducted by the printer. After 30 seconds from completion of the printing, an image formed was strongly rubbed five times with a line marker. As a result, no blue smeared image trailing edge was observed.

### COMPARATIVE EXAMPLE 3

Four parts by mass of a water-soluble dye, C.I. Direct Blue 199 and 17 parts by mass of diethylene glycol were stirred in 79 parts by mass of distilled water to obtain a water-soluble dye ink that was very transparent and showed a blue color. The plain paper sprayed with hydrochloric acid prepared in EXAMPLE 22 and plain paper sprayed with no hydrochloric acid were used as recording media. The evaluation was made in the same manner as in EXAMPLE 22.

(1) Solid printing of a square of 50 mm×50 mm was conducted by the above-described printer. After 30 seconds from completion of the printing, a recorded area was strongly pushed with a finger. As a result, the ink adhered to the finger in both cases where the plain paper sprayed with hydrochloric acid and the plain paper sprayed with no hydrochloric acid were respectively used as recording media. (2) Solid printing of a square of 50 mm×50 mm was conducted by the printer. After 30 seconds from completion of the printing, an image formed was strongly rubbed once with a line marker. As a result, a blue smeared image trailing edge was observed in both cases where the plain paper sprayed with hydrochloric acid and the plain paper sprayed with no hydrochloric acid were respectively used as recording media.

### EXAMPLE 23

A block polymer having 2-ethoxyethyl vinyl ether (EOVE) exhibiting hydrophilicity at a temperature lower than 20° C. and hydrophobicity at a temperature not lower than 20° C. as the component A (IBVE-r-BPhOVE) of the block polymer obtained in EXAMPLE 20 was obtained by using 12 mmol of EOVE in place of 12 mmol of BPhOVE in EXAMPLE 20. Other synthesizing conditions were the same as those in EXAMPLE 15. The identification of the compound synthesized was conducted by means of GPC and NMR. Mn was 29,200, and Mw/Mn was 1.18. Mn means a number average molecular weight, and Mw denotes a weight average molecular weight.

Twenty six parts by mass of the diblock polymer thus obtained and 10 parts by mass of an oil-soluble dye, Oil Blue N (the same as a trade name, product of Aldrich Co.) were dissolved in dimethylformamide, and the resultant solution was converted into a water phase with 400 parts by mass of distilled water to obtain an ink composition. The oil-soluble dye neither separated nor precipitated even after left to stand for 10 days.

This dye-dispersed composition was cooled to 10° C. to collapse the polymer micelle to dissolve the polymer in water. As a result, the dye and the dye solution were separated from each other, and the water layer became colorless. From this result, it was confirmed that the coloring material was included.

1. A polymer compound comprising a first repeating unit structure exhibiting anionicity and a second repeating unit structure different from the first repeating unit structure, wherein the compositional ratio of the first repeating unit structure to the second repeating unit structure gradually changes along a monomer chain.

2. The polymer compound according to claim 1, wherein the second repeating unit structure is at least one repeating unit structure exhibiting hydrophilicity.

3. The polymer compound according to claim 1, comprising at least two block segments, wherein in at least one of the block segments the compositional ratio of the first repeating unit structure exhibiting anionicity to the second repeating unit structure different from the first repeating unit structure gradually changes along the monomer chain.

4. A polymer compound comprising at least two block segments, wherein at least one segment of the block segments contains a repeating unit structure exhibiting anionicity and a repeating unit structure exhibiting hydrophilicity.

5. The polymer compound according to claim 1, wherein the block polymer is amphipathic.

6. The polymer compound according to claim 1, which further comprises a segment having hydrophobicity.

7. The polymer compound according to claim 1, which comprises a polyalkenyl ether structure as a repeating unit structure.

8. The polymer compound according to claim 7, which comprises a polyvinyl ether structure as a repeating unit structure.

9. The polymer compound according to claim 8, wherein the repeating unit structure exhibiting anionicity is a repeating unit structure represented by the following general formula (1), and the repeating unit structure exhibiting the hydrophilicity is a repeating unit structure represented by the following general formula (2): 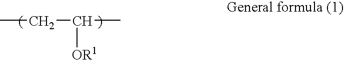
wherein R¹ is —X—(COO⁻)ₛ, and X is a linear, branched or cyclic alkylene group having 1 to 20 carbon atoms, or —(CH(R²)—CH(R³)—O)ₚ—(CH₂)ₘ—, —(CH₂)ₘ—(O)ₙ—(CH₂)_{q}— or a structure that at least one of these methylene groups is substituted by a carbonyl group or an aromatic structure, in which s is an integer of from 1 to 3, p is an integer of from 1 to 18, m is an integer of from 1 to 36, n is 1 or 0, q is an integer of from 1 to 18, and R² and R³ are alkyl groups and may be the same or different from each other; 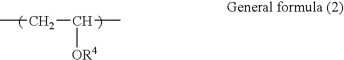
wherein R⁴ is hydrogen or selected from —(CH(R⁵)—CH(R⁶)—O)ₚ—R⁷ and —(CH₂)ₘ—(O)ₙ—R⁷, in which p is an integer of from 1 to 18, m is an integer of from 1 to 36, n is 1 or 0, R⁵ and R⁶ are, independently of each other, hydrogen or —CH₃, and R⁷ is hydrogen or a linear, branched or cyclic alkyl group having 1 to 5 carbon atoms.

10. The polymer compound according to claim 1, wherein the content of the repeating unit structure exhibiting the hydrophilicity in the block polymer is 50 mol % or more.

11. A polymer-containing composition comprising the polymer compound according to claim 1, a solvent or dispersing medium, and a functional material.

12. The polymer-containing composition according to claim 11, wherein the functional material is included in the block polymer.

13. An ink composition comprising a coloring material as the functional material as set forth in claim 11.

14. A method for applying an ink, which comprises the steps of preparing the ink composition according to claim 13 and applying the ink composition to a medium.

15. An apparatus for applying an ink, which comprises an ink-applying means for applying the ink composition to a medium by causing energy to act on the ink composition according to claim 13 and a driving means for driving the ink-applying means.
